(19) United States
(12) Patent Application Publication
(10) Pub. No.: US 2004/0117388 A1
(43) Pub. Date: Jun. 17, 2004

(54) Method, apparatus and programs for delivering information

(76) Inventors: Yasuhiko Inaba, Yokohama (JP); Tadataka Matsubayashi, Kawasaki (JP); Takaaki Yayoi, Yokohama (JP); Makoto Uchikado, Takatsuki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/652,000

(22) Filed: Sep. 2, 2003

(30) Foreign Application Priority Data
Sep. 2, 2002 (JP) 2002-256802

(51) Int. Cl. G06F 17/00

(52) U.S. Cl. 707/100

(57) ABSTRACT

In a system which delivers documents which fulfill a delivery condition set by a user, when a request to change the delivery condition is entered, the system notifies the user what documents would be no longer delivered after the change so that the user can evaluate the change of the delivery condition. To be more concrete, documents which have been delivered to users are preserved and, when it is requested by a user to change the user's delivery condition, the system applies the changed delivery condition to the preserved documents and presents what documents would be no longer delivered to the user due to inconsistency with the new delivery condition.

### BACKGROUND OF THE INVENTION

1. Field of the Invention

The present invention relates to an information delivery technique in which documents that meet a delivery condition registered in advance by a user are delivered to the user.

2. Description of the Related Art

Every moment recently, large amounts of news and other electronic documents (hereinafter denoted as document information) are being delivered to users by electronic mail and the like. Information sources which transmit information through the World Wide Web (WWW) are also rapidly increasing and hence immense amounts of documents are being collected therefrom using information collecting robots and the like. Consequently, there has arisen an intensifying demand for an information filtering system which retrieves document information containing information of the user's interest from such great amounts of documents and delivers them to the user.

An example of this information filtering system is disclosed in Japanese Patent Laid-open No. 2000-339346 (hereinafter denoted as Reference 1). In Reference 1, a sample document (hereinafter denoted as a seed document) indicating what information is needed is entered as a delivery condition in advance by the user. Each time document information occurs, the information filtering system calculates the degree of relevance of the document to the user's seed document according to a prescribed method and, only if the degree of relevance exceeds a prescribed threshold, sends the document to the user.

In addition, there is a technique called relevance feedback which allows the user to evaluate each document received as the result of filtering and reflect the evaluation so as to raise the subsequent filtering accuracy. In this relevance feedback, the user evaluates each delivered document by entering “wanted information” (hereinafter denoted as fit information) or “unwanted information” (hereinafter denoted as unfit information) and, based on this evaluation, the data containing the user's delivery conditions (hereinafter denoted as a profile) is modified. An example of an information filtering system using this technique is disclosed in Japanese Patent Laid-open No. 2001-256253 (hereinafter denoted as Reference 2).

FIG. 2 shows the outline of processing by an information filtering system according to Reference 2. First, from a seed document 202 entered by a user 201, character strings (hereinafter denoted as characteristic character strings) which characteristically represent the content of the seed document are extracted. The extracted characteristic character strings are registered to a fitness profile 203 (\mathring{1}). In this example shown, a seed document 202, “Topics of Professional Baseball” is set by a user 201 who seeks information about “Professional Baseball”. Here, the characteristic character strings may be those extracted by using, for example, a method disclosed in Japanese Patent Laid-open No. 11-143902 (hereinafter denoted as Reference 3). The characteristic character strings may also be either words extracted from the seed document by such means as morphological analysis or simply extracted n-grams. Then, if a filtering module 206 receives supplied document information 207 from an information resource 205, it calculates the degree of fitness of each document information 207 to the fitness profile 203. The degree of fitness is calculated by using, for example, the following equation:

S(D)=Σ^{N}ᵢ{.Frq(i)×w(i)} (Equation 1)

where, S(D) is the degree of fitness of document information D to the profile, Frq(i) is the number of times characteristic character string i appears in document D, w(i) is a weight applied to characteristic character string i in the profile and Σ means that Frq(i)×w(i) is summed up for all characteristic character strings in the profile. According to this equation, the degree of fitness is calculated higher if characteristic character strings given higher weights in the profile appear frequently in the document. If the degree of fitness exceeds a prescribed threshold, the document information is delivered to the pertinent user 201. In this example of FIG. 2, only document information 208 and 210 of document information 207 exceed the prescribed threshold and are delivered to the user 201 (\mathring{2})

Assume that document 210 is not information desired by the user 201 since it covers a topic of “soccer” not of “professional baseball”. In this case according to Reference 2, the user 201 enters “Document information 210 is not desired”. In response to this entry, characteristic character strings are extracted from document information 210 and added to an unfitness profile 204 which contains data representing things in which the user is not interested (\mathring{3}).

In the information filtering system 206, since this, each document transmitted from the information resource 205 is not delivered to the user unless not only the degree of fitness to the fitness profile 203 is higher than the prescribed threshold but also the degree of fitness to the unfitness profile 204 is lower than a prescribed threshold. In this scheme according to Reference 2, it is possible to interactively raise the appropriateness of document selection for delivery by utilizing the user's evaluation on the delivered document information.

### BRIEF SUMMARY OF THE INVENTION

However, the information filtering system having the functions described in Reference 2 has a problem as mentioned below. A document sometimes has a plurality of view-points. For example, it is not so rare that one document mainly concerns “soccer” but partly refers to “professional baseball”. If this document is evaluated as “unwanted information” by a user who thinks “soccer” topics are not necessary, the filtering system may judge that “professional baseball” topics are also not wanted by the user and modify the profile according to the judgment, causing a situation in which desired information is not delivered contrarily to the user's intention. It is also possible that a wrong evaluation is entered if the user misunderstands the content of a document or makes a mistake in operation. After this wrong evaluation, some of the wanted information would not be delivered to the user, too.

For example, assume that in the example of FIG. 2, the document information 210 contains a part concerning “professional baseball” although the document information 210 is evaluated as “unwanted information” by the user 201 who seeks information about “professional baseball”. In this case, it is possible that “professional”, “baseball” and other character strings which represents the things about which the user 201 seeks information may be extracted from the document information 210 and added to the unfitness profile 204. After this addition, information about “professional baseball” would not be delivered to the user.

When wanted information is not delivered, another problem arises. It is not clear to the user whether this situation is caused since wanted information has not actually occurred or the profile is improperly modified due to his evaluation interpreted contrarily to his intention. That is, not only the user cannot acquire documents which would be delivered if the feedback is not done contrarily to his intention but also he cannot know the reason why wanted information is not delivered.

To solve these problems, it is an object of the present invention to allow the user, when his delivery condition is to be modified in response to his operation, to be notified of the document information that would be excluded from delivery by the modification so that the user can evaluate the modification.

According to an aspect of the present invention, there is provided an information delivery method in which a delivery condition set by a user is applied to each document information sent from an information source and, if the document fulfills the delivery conditions, it is delivered to the user, which method comprises the steps of: storing the document information delivered to the user in storage means; if it is requested by the user to modify the delivery conditions, applying the modified delivery conditions to the stored documents; and notifying the user of the documents which do not fulfill the modified delivery condition and therefore would not be delivered to the user.

### BRIEF DESCRIPTION OF THE DRAWINGS

FIG. 1 is a diagram showing the system configuration of an information filtering system according to a first embodiment of the present invention;

FIG. 2 shows the outline of processing in an information filtering system according to a related art;

FIG. 3 is a PAD (Problem Analysis Diagram) showing a procedure of processing by a main program 108 in the first embodiment;

FIG. 4 is a PAD showing a procedure of processing by an unfitness feedback program 113 in the first embodiment;

FIG. 5 is an example of a confirmation screen displayed when document-evaluation is entered by the user in the first embodiment;

FIG. 6 is a diagram showing the system configuration of an information filtering system according to a second embodiment of the present invention;

FIG. 7 is a PAD showing a procedure of processing by a main program 606 in the second embodiment;

FIG. 8 is a PAD showing a procedure of processing by a condition change rehearsal program 603 in the second embodiment;

FIG. 9 is an example of a confirmation screen displayed when delivery condition change request is entered by the user in the second embodiment;

FIG. 10 is a diagram showing the system configuration of an information filtering system according to a third embodiment of the present invention;

FIG. 11 is a PAD showing a procedure of processing by a main program 1010 in the third embodiment;

FIG. 12 is a PAD showing a procedure of processing by an additional information display program 1001 in the third embodiment; and

FIG. 13 is an example of a delivery information display screen presented to the user in the third embodiment.

### DETAILED DESCRIPTION OF THE INVENTION

Preferred embodiments of the present invention will be described below in detail with reference to the drawings. Note that this description shall not limit the scope of the present invention.

Firstly, a first embodiment is described. The first embodiment is designed to guide the user through interactive interface so as to perform proper relevance feedback consistently with his intention and prevent improper relevance feedback contrary to his intention.

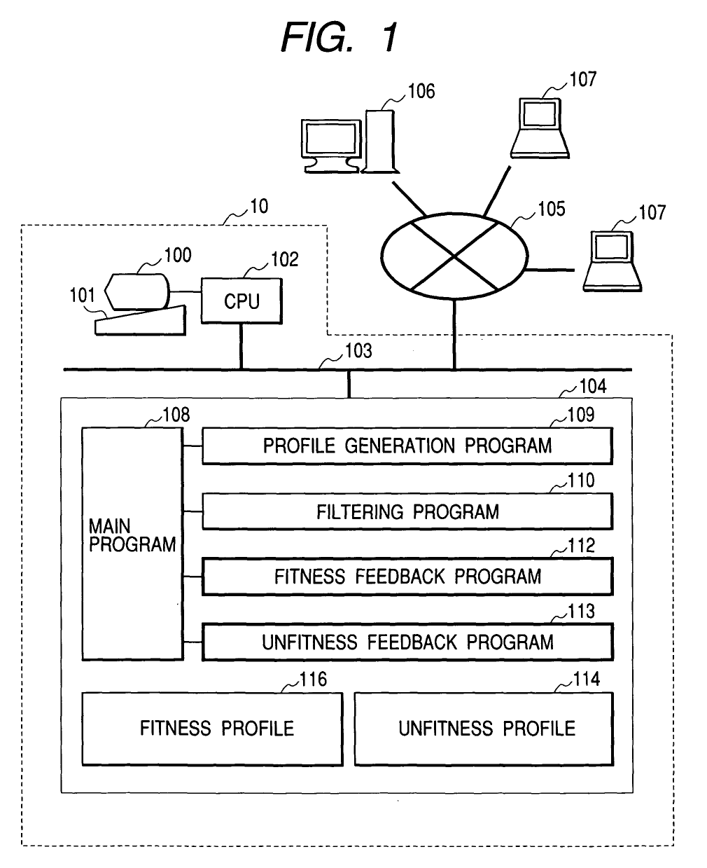

FIG. 1 shows the system configuration of an information filtering system according to this embodiment. The information filtering system 10 in this embodiment comprises a display 100, a keyboard 101, a central processing unit (CPU) 102, a main memory 104 and a bus 103 which connects them. Via a communication circuit 105 such as a LAN (Local Area Network), the bus 103 is also connected to a document information delivery device 106 which transmits document information and users 107 which use the information filtering system 10. Each of the information delivery device 106 and users 107 is a computer or terminal device which is connected to the information filtering system 10. The document information delivery device 106 delivers electronic document information to the information filtering system 10 by electronic mail or the like and presents documents via the Internet. The document information delivery device 106 is generally supposed to be set up at an information originator company such as a news agency or newspaper publishing company although it may be placed anywhere. Each user 107 registers delivery conditions with the information filtering system 10 by electronic mail. To each user 107, documents retrieved based on the pertinent delivery conditions are delivered from the filtering system 10 by electronic mail.

Although in the following description of the embodiments of the present invention, it is assumed that the document information delivery device 106 delivers documents to the filtering system 10 by electronic mail or the like, they may also be configured in such a manner that an information collecting apparatus, not shown, collects documents that are presented onto the Internet by the document information delivery device 106. In addition, they may be configured in such a manner that users 107 register delivery conditions with the filtering system 10 by electronic mail or through an Internet site. Likewise, although it is assumed in the following description that documents selected based on a delivery condition, detailed below, are delivered to the pertinent user by electronic mail, this may also be modified in such a manner that these documents are presented on an Internet site.

In the main memory 104, a main program 108, a profile generation program 109, a filtering program 110, a fitness feedback program 112, an unfitness feedback program 113, fitness profiles 116 and unfitness profiles 114 are stored. These programs are executed by the CPU 102. It is also possible to store these programs and profiles on such recording medium as a hard disk (not shown) or flexible disk (not shown) which allows read and write by the computer.

The main program 108 is started when instructed through the keyboard 101 by the administrator of the information filtering system 10. It is a system control program to control the information filtering system 10. Its flows of processing are described later in detail.

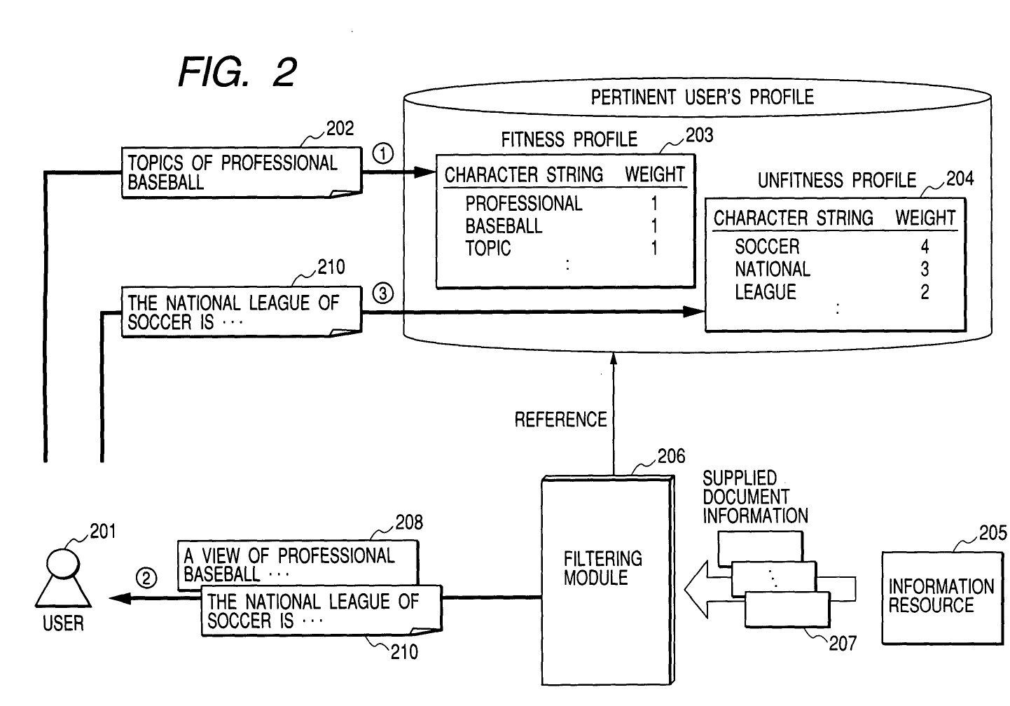

The profile generation program 109 generates characteristic character strings from a seed document entered from a user 107 and stores the generated strings in the fitness profile 116. The method of generating profiles and the contents of the generated fitness profiles are same as described with FIG. 2. A fitness profile 116 stores characteristic character strings representing things in which the user is interested while an unfitness profile 114 contains characteristic character strings representing things in which the user is not interested.

The filtering program 110 receives document information from the document information delivery device 106 and transmits them to users who want to receive them. By using such a technique as disclosed in Reference 1, this program calculates the degree of fitness of each document received from the document information delivery device 106 by applying each user's fitness profile 116 and unfitness profile 114 according to a prescribed method. If the degree of fitness of a document, calculated for a user 107, is higher than a prescribed threshold, the document is delivered to the user 107 since the delivery condition of the user 107 is considered to be satisfied by the document.

The fitness feedback program 112 and unfitness feedback program 113 respectively modify each user's fitness profile 116 and unfitness profile 114 based on the user's evaluation “fit” or “unfit” made on each document information received from the filtering system 10. Their flows of processing are described later in detail.

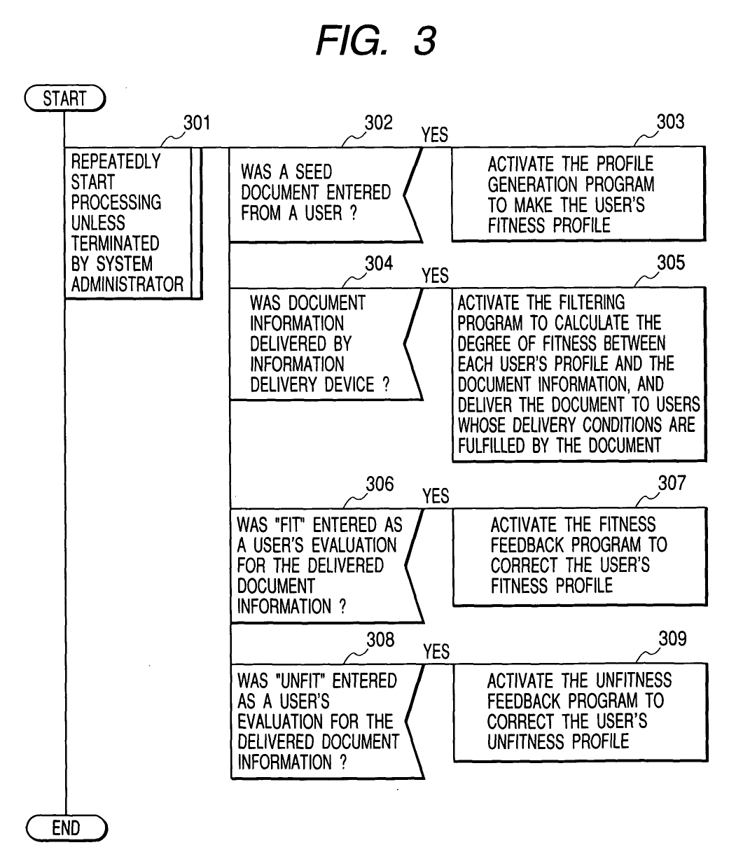

Flows of processing by the main program 108 in the first embodiment are described below with reference to a PAD (Problem Analysis Diagram) in FIG. 3. In step 301, the main program 108 repeatedly initiates a sequence of steps 302 through 309 unless instructed by the system administrator to terminate the system. Firstly, if it is judged that a seed document is entered from the user 107 in step 302, step 303 activates the profile generation program 109 to set the fitness profile 116 of the user 107.

Then if it is judged in step 304 that a document is sent from the document information delivery device 106 or a document resource, step 305 activates the filtering program 110 to calculate the degree of fitness between the document information and each user's profile and deliver the document to users for which the degree of fitness is calculated higher than a prescribed threshold. For example, the degree of fitness may be obtained by subtracting a second degree of fitness from a first degree of fitness, where the first degree of fitness is calculated by applying Equation 1 to character strings in the document which are respectively identical to the weighted characteristic character strings registered with the fitness profile 116 while the second degree of fitness is calculated by applying Equation 1 to character strings in the document which are respectively identical to the weighted characteristic character strings registered with the unfitness profile 114.

Then, in step 306, if it is judged that “fit” is entered from a user 107 as the user's evaluation on at least one of the delivered documents, step 307 activates the fitness feedback program 112 to modify the pertinent user's fitness profile 116. Then, in step 308, if it is judged “unfit” is entered from the user 107 as the user's evaluation on at least one of the delivered documents, step 309 activates the unfitness feedback program 113 to modify the pertinent user's unfitness profile 114. How the profile is modified by the fitness feedback program 112 and unfitness feedback program 113 is described later. The main program 108 proceeds with processing in this manner.

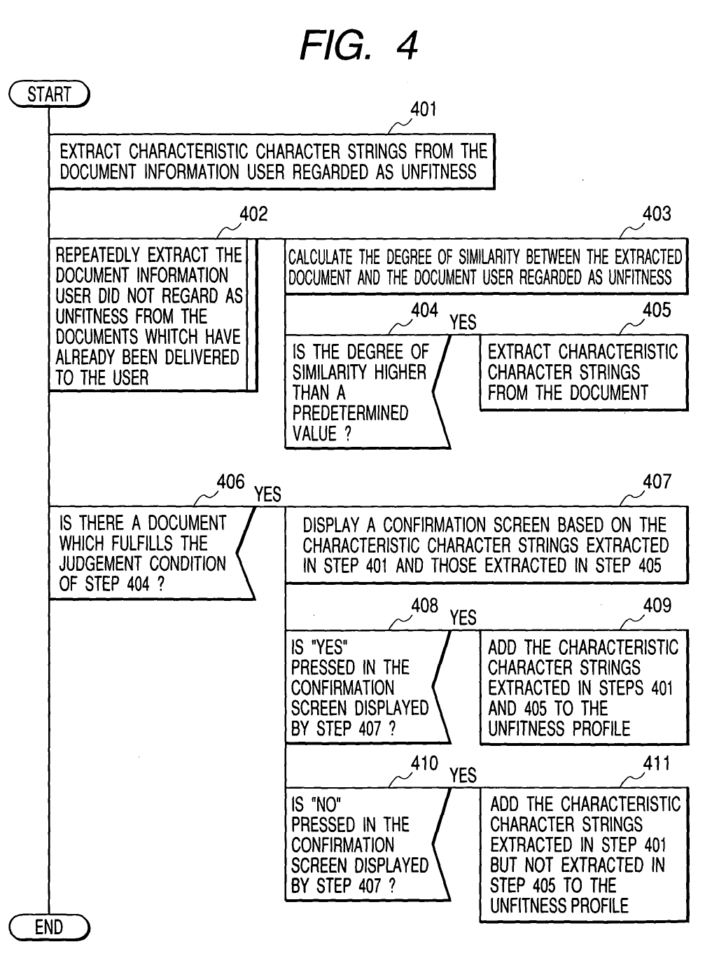

The following describes the fitness feedback program 112 and unfitness feedback program 113 which are activated respectively in steps 307 and 309. If “fit” or “unfit” is entered as a user's evaluation on a document received by the user, the feedback program considers the possibility that the feedback to be done due to the evaluation is contrary to the user's intention and, if the possibility is high, it asks the user for confirmation so that any feedback is implemented along with the user's intention. Firstly, with reference to a PAD in FIG. 4, the following describes the flows of processing by the unfitness feedback program 113 which is activated if “unfit” is entered as a user's evaluation.

Firstly, in step 401, the unfitness feedback program 113 extracts characteristic character strings from the document information evaluated as “unfit” by a user 107. Then, in step 402, from the documents which have so far been delivered to the user 107 and stored in a storage device (such as a hard disk device), a document not evaluated as “unfit” is picked up to initiate a processing sequence of steps 403 through 405. This is repeated until the last such document is extracted. In step 403, the degree of similarity between the document extracted in step 402 and the document evaluated as “unfit” by the user is calculated. The degree of similarity may be calculated by the vector space method or the like. For example, the degree of similarity may also be calculated by extracting characteristic character strings from these documents, generating a temporary similarity calculation profile and applying Equation 1 to the extracted characteristic character strings. This means that if a past document is much similar to the document evaluated by the user as “unfit”, this past document is much likely to be evaluated as “unfit”. Then if it is judged in step 404 that the degree of similarity calculated in step 403 is higher than a predetermined value, step 405 extracts characteristic character strings from the extracted document.

Then if it is judged in step 406 that the judgment condition of step 404 is satisfied by one or more documents, steps 407 through 411 are executed. Firstly, step 407 displays a confirmation screen based on the characteristic character strings extracted in step 401 and the characteristic character strings extracted in step 405.

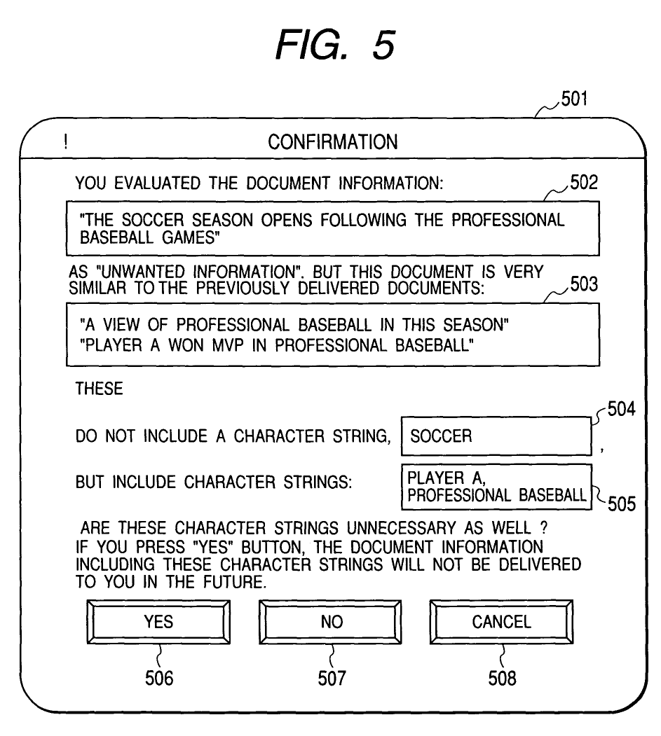

With reference to FIG. 5, the content of the confirmation screen displayed in step 407 is described below. It is assumed here that a document 502 titled “The soccer season opens following the professional baseball games” was evaluated by the user as “unfit”. The screen indicates documents 503 which were delivered to the user in the past and are similar to the document 502. The degree of similarity between these documents is calculated in step 403. In addition, the confirmation screen indicate characteristic character string 504 which appear only in the document 502 evaluated as “unfit” by the user and characteristic character strings 505 which appear in the documents 503. The user refers to this information and judges whether not only information relevant to the characteristic character string 504 but also information relevant to the characteristic character strings 505 are unnecessary. If so, the user depresses a “YES” button 506 and, if not, depresses a “NO” button 507. To cancel the relevance feedback processing, the user depresses a “CANCEL” button 508.

Then if the “YES” button 506 in the confirmation screen displayed in step 407 is depressed by the user 107 in step 408, the characteristic character strings extracted in step 401 and/or step 405 are added to the user's unfitness profile 114. On the other hand, if the “NO” button 507 in the confirmation screen displayed by step 407 is depressed by the user 107 in step 410, the characteristic character strings which were extracted in step 401 but not extracted in step 405 are added to the user's unfitness profile 114.

In steps 409 and 411, there is a possibility that character strings wanted by the user may be added together with unwanted character strings. However, this wrong addition of noise character strings can be prevented by collating the extracted characteristic character strings with the character strings registered with the fitness profile 116 and inhibiting any character strings from being added to the unfitness profile 114 if they are already registered with the fitness profile 116.

The flows of processing of the fitness feedback program 112 are substantially the same as the flows of processing of the unfitness feedback program 113 shown in FIG. 4 except that characteristic character strings are added to the fitness profile 116 in steps 409 and 411. There is also a possibility in steps 409 and 411 that character strings unwanted by the user may be added together with wanted character strings. However, this wrong addition of noise character strings can be prevented by collating the extracted characteristic character strings with the character strings registered with the unfitness profile 114 and inhibiting any character strings from being added to the fitness profile 116 if they are already registered in the unfitness profile 114.

What are made possible by the aforementioned fitness feedback program 112 and unfitness feedback program 113 are summarized below. For example, if “unfit” is entered by a user as his evaluation on a document, characteristic character strings 504 and 505 are indicated to the user in the screen of FIG. 5, allowing the user to add both of them to unfitness profile 114 if the user is not interested in them. That is, the user can add every unwanted characteristic character string to the unfitness profile 114.

Meanwhile if of the indicated characteristic character strings 504 and 505, only the characteristic character string 504 that appears in the document evaluated as “unfit” is not wanted by the user, the user can add only the characteristic character string 504 to the unfitness profile 114. That is, it is possible to prevent the user from adding an actually wanted characteristic character string to the unfitness profile 114.

In addition, another judgment method is also made possible. The document 503 may be viewed as a sample of the documents that have so far been delivered to the user but will not be delivered if the delivery condition is changed by this relevance feedback. Accordingly, if such documents as the document 503 seem still necessary, the user can continue receiving them as before by depressing the “NO” button 507. This allows the user to properly reflect his intention in the relevance feedback since he can prevent the relevance feedback if the feedback is not along with his intention.

Note that step 402 may be modified in such a manner that from the documents which have so far been delivered to the user and stored in a storage device, documents evaluated as “fit” by the user are extracted for processing in steps 403 through 405. This also allows the user to judge whether this feedback is appropriate or not since the user is notified of documents that have so far been delivered but would be no longer delivered if the user's current evaluation is reflected.

Then, a second embodiment of the present invention is described. In the second embodiment, when a user is about to modify his delivery conditions, the user can judge whether this modification is appropriate for him. This embodiment prevents the user from becoming impossible to obtain wanted information because the delivery conditions are changed contrarily to his intention.

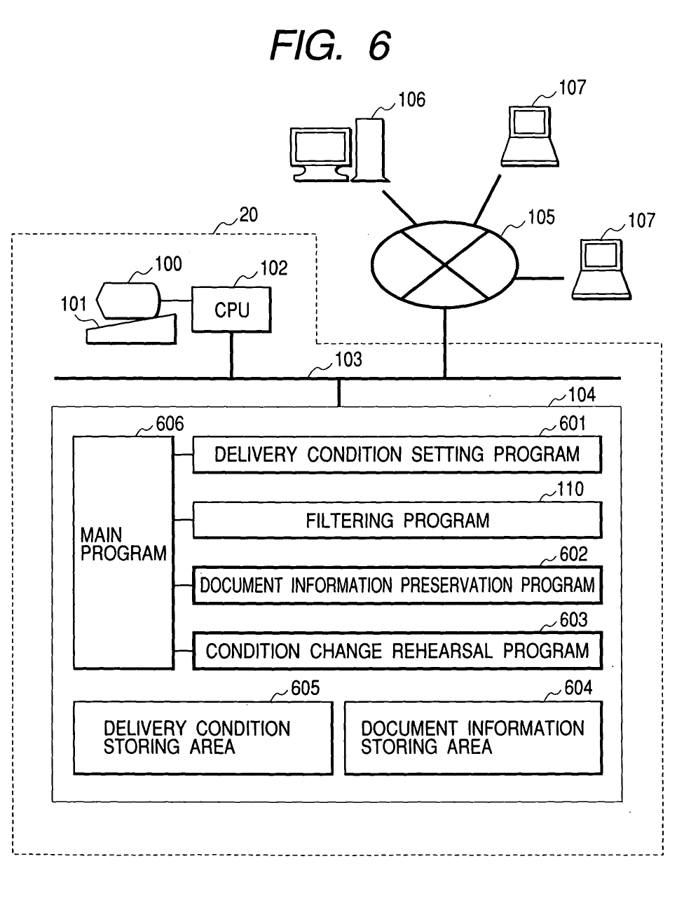

FIG. 6 shows the system configuration of an information filtering system 20 according to the second embodiment. The system configuration of the second embodiment is same as that of the first embodiment except that the main memory 104 contains a delivery condition setting program 601, a document information preservation program 602 and a condition change rehearsal program 603 instead of the profile generation program 109, fitness feedback program 112 and unfitness feedback program 113, respectively, stored in the main memory 104 of the first embodiment. In addition, a main program 606 in the main memory 104 differs in processing from that of the first embodiment. Further, a delivery condition storing area 605 and a document information storing area 604 are reserved in the main memory 104.

Delivery conditions entered by users are stored in the delivery condition storing area 605 by the delivery condition setting program 601. It is assumed here that a delivery condition is a keyword or a combination of keywords and Boolean operators (logical addition condition, logical multiplication condition, etc.) although it may also be the identifier of a document information delivery device 106, a range of delivery date or the like. The document information preservation program 602 stores each delivered document information in the document information storing area 604 together with information indicating the destination user. The condition change rehearsal program 603, if it is requested by a user 107 to change his delivery conditions stored in the delivery condition storing area 605, exemplifies the user how the new delivery conditions would change the delivery result.

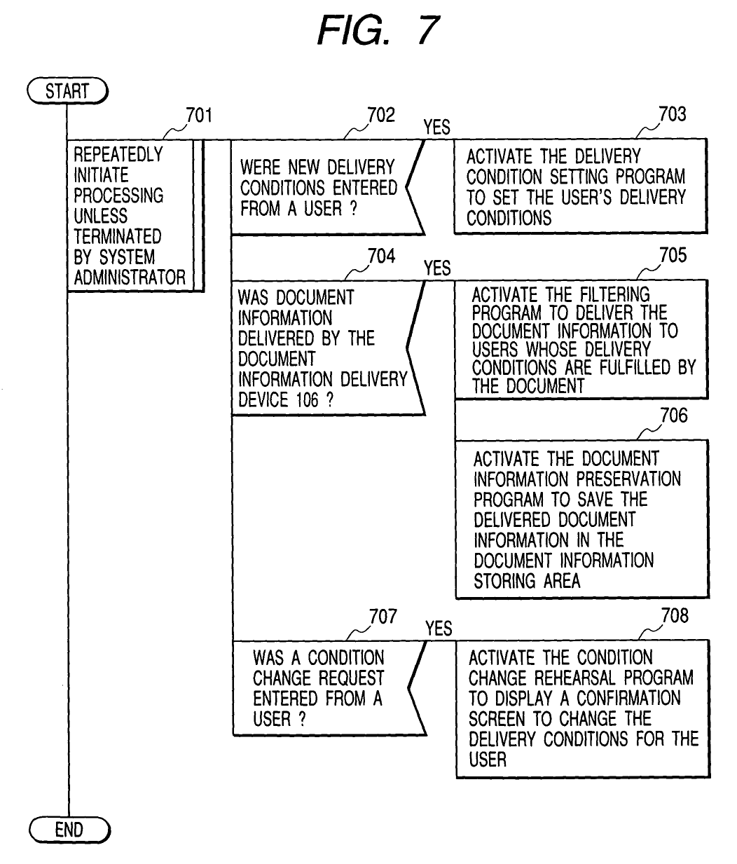

Flows of processing by the main program 606 in the second embodiment are described below with reference to a PAD (Problem Analysis Diagram) of FIG. 7. In step 701, the main program 606 repeatedly initiates a sequence of steps 702 through 708 unless instructed by the system administrator to terminate the processing of the filtering system 20. Firstly, if it is judged that new delivery conditions are entered from a user 107 in step 702, step 703 activates the delivery condition setting program 601 to set and write the user's delivery conditions to the delivery condition storing area 605.

Then if it is judged in step 704 that a document is sent from the document information delivery device 106, step 705 activates the filtering program 110 to judge whether the document fulfils each user's delivery conditions stored in the delivery condition storing area 605 and delivers the document to users whose delivery conditions are fulfilled by the document. Then step 706 activates the document information preservation program 602 to store the delivered document information in the document information storing area 604.

Then if it is judged in step 707 whether a delivery condition change request is entered by a user, step 708 activates the condition change rehearsal program 603 to display a confirmation screen to the pertinent user. Flows of processing by the condition change rehearsal program 603 and the displayed screen are described later in detail. The main program 606 proceeds with processing in this manner.

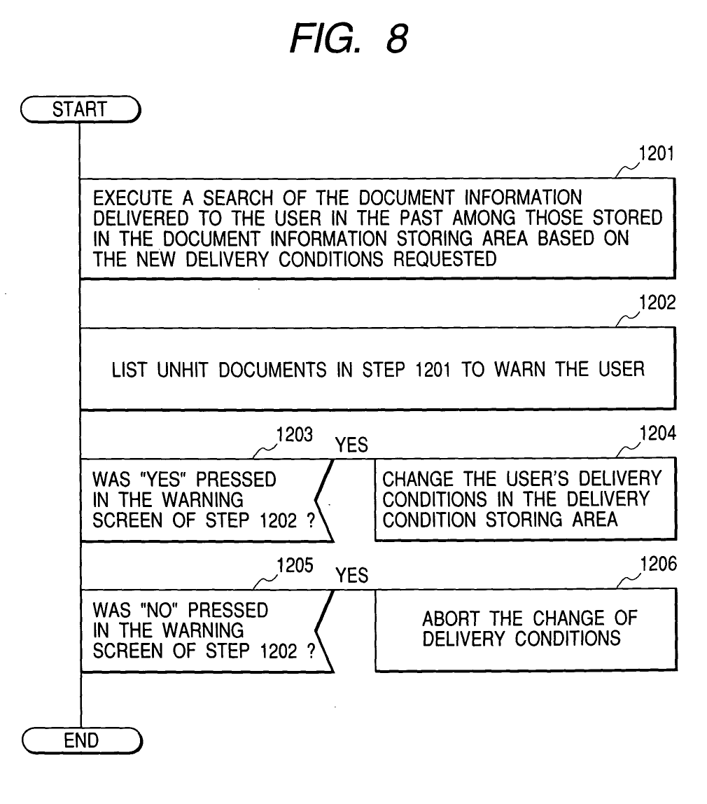

With reference to a PAD of FIG. 8, the following describes the flows of processing by the condition change rehearsal program 603 which is activated in step 708 by the main program 606 as shown in FIG. 7. As mentioned above, this program, if it is requested by a user 107 to change his delivery conditions stored in the delivery condition storing area 605, exemplifies the user how the new delivery conditions would change the delivery result.

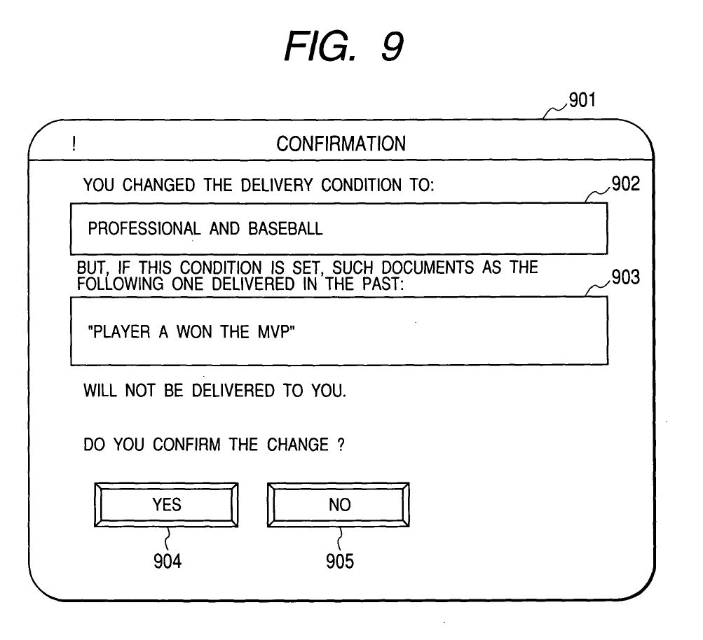

Firstly, in step 1201, the documents delivered to the user in the past among those stored in the document information storing area 604 are searched for the requested new delivery conditions. Then, step 1202 warns the user of documents that were not hit in the search of step 1201. That is, step 1202 extracts and displays documents that do not fulfill the new delivery conditions. FIG. 9 shows an example of the screen displayed in this step for the user.

Firstly, this confirmation screen 901 displays a new delivery condition 902 the user intends to set. Then, the screen lists documents 903 that do not fulfill the new delivery condition although delivered in the past to the user. From these documents listed as examples, the user can have an idea of what documents would be no longer delivered if the new delivery condition 902 is set. That is, this screen provides information useful in determining whether to confirm the delivery condition 902. Accordingly, the user can judge whether the delivery condition 902 is appropriate or not for the user. The user depresses a “YES” button 904 if the delivery condition 902 is appropriate. If the delivery condition 902 is not appropriate, the user depresses a “NO” button 905.

Then if the “YES” button 904 in the confirmation screen displayed in step 1202 is depressed by the user in step 1203, the user's delivery conditions in the delivery condition storing area 605 are changed as requested. If the “NO” button 905 in the confirmation screen displayed in step 1202 is depressed by the user in step 1205, the change of the delivery conditions is aborted in step 1206.

As described above, since the condition change rehearsal program 603 allows the user to judge whether the new delivery conditions to be set are appropriate for him, it is possible to prevent the inappropriate delivery conditions from making wanted documents unavailable. If the user does not need any of the listed documents 903, the user has only to depress the “YES” button 904. If some of the listed documents 903 are needed, the user can depress the “NO” button 905, modify the delivery condition 902 and review the documents 903 to be listed again.

Note that the relevance feedback-included information filtering system, cited as the first embodiment, may be modified in such a manner that if the profile is to be changed by a relevance feedback, the new profile is tested with the documents delivered in the past to the user in order to check that the relevance feedback is appropriate or not. This system, a variant of the first embodiment, comprises: a profile generation program 109, filtering program 110, fitness feedback program 112, unfitness feedback program 113, fitness profile 116 and unfitness profile 114 which are included in the first embodiment; and a document preservation program 602, condition change rehearsal program 603 and document information storing area 604 which are included in the second embodiment. However, the condition change rehearsal program 603 in this variant system differs in processing. If new characteristic character strings are added to the fitness profile 116 or unfitness profile 114 by the fitness feedback program 112 or unfitness program 113, the condition change rehearsal program 603 calculates the degree of fitness of each document delivered to the pertinent user among the documents stored in the document information storing area 604 in the same manner as step 305. If one or more documents are not hit, the condition change rehearsal program 603 warns the user by listing these documents as samples of the documents that would no longer be delivered to the user. If the user selects “YES”, the condition change rehearsal program 603 makes the relevance feedback effective. If the user selects “NO”, the rehearsal program 603 cancels the feedback. Since this allows the user to have an idea how the subsequent delivery results would be changed by the relevance feedback, the user can judge at this time whether the relevance feedback is appropriate and, if not appropriate, abort the modification of the profile. It is therefore possible to prevent the user from making wanted documents unavailable by unintended feedbacks.

The following describes a third embodiment of the present invention. The third embodiment allows the user to make wanted documents available even after an unintended relevance feedback is implemented and cancel the relevance feedback so as to restore the profile to its former state.

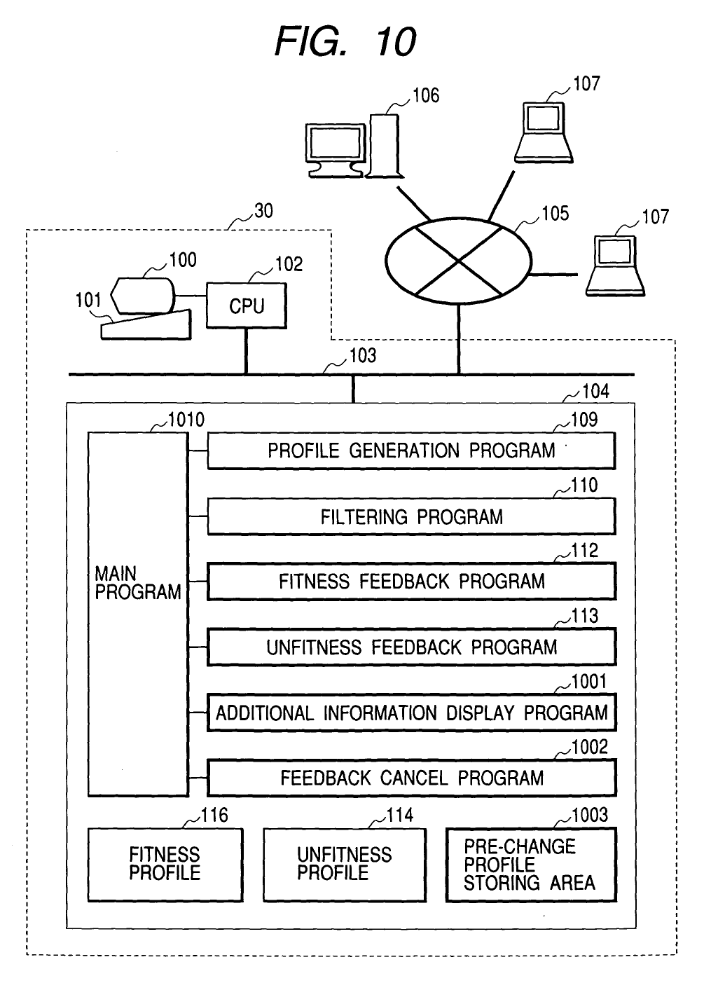

FIG. 10 shows the system configuration of an information filtering system according to the third embodiment. The system configuration by the third embodiment is the same as the first embodiment except that its main memory 104 stores: an additional information display program 1001 and feedback cancel program 1002 in addition to a profile generation program 109, filtering program 110, fitness feedback program 112 and unfitness feedback program 113 which are identical to those of the first embodiment; and a pre-change profile storing area 1003 in addition to a fitness profile 116 and unfitness profile 114 which are identical to those of the first embodiment. In addition, the main program 1010 is different in processing from the main program 108 of the first embodiment.

To each user, the additional information display program 1001 delivers document information as additional information which fulfill the user's additional conditions as described later besides the documents which are delivered based on his fitness profile 116 and unfitness profile 114. Flows of processing by the additional information display program 1001 are described later in detail. The feedback cancel program 1002 restores a profile changed by the last relevance feedback to its former state. Flows of processing by this program are described later in detail. The pre-change profile storing area 1003 stores each user's former fitness profile and unfitness profile changed by the last relevance feedback. That is, the user's second latest fitness profile and unfitness profile are stored in this area.

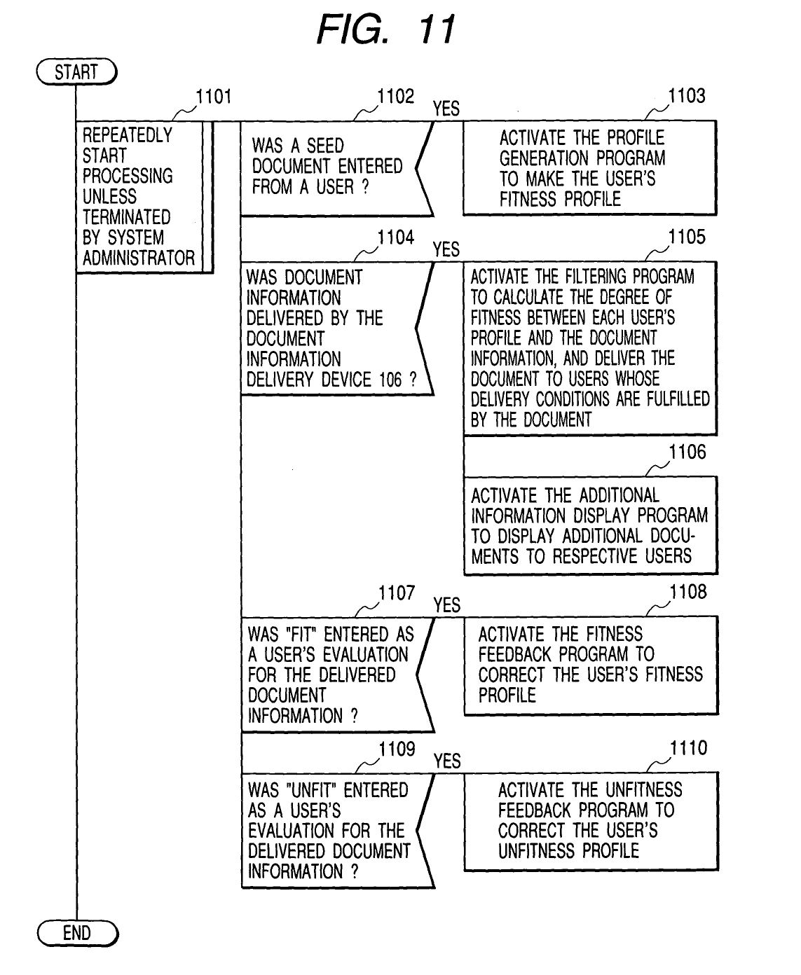

Flows of processing by the main program 1010 in the third embodiment are described below with reference to a PAD (Problem Analysis Diagram) of FIG. 11. In step 1101, the main program 1010 repeatedly initiates a sequence of steps 1102 through 1110 unless instructed by the system administrator to terminate the processing of the system 30. Firstly, if it is judged in step 1102 that a seed document from which a search condition is to be derived is entered from a user 107, step 1103 activates the profile generation program 109 to set the fitness profile 116 of the user 107. Step 1103 may also be modified so as to generate the unfitness profile 114 as well as the fitness profile 116.

Then if it is judged in step 1104 that document information is sent from the document information delivery device 106, steps 1105 and 1106 are executed. Firstly, step 1105 activates the filtering program 110 to calculate the degree of fitness between the document information and each user's profile and deliver the document to users for which the degree of fitness is calculated higher than a predetermined value. Step 1105 provides the same processing as step 305 in FIG. 3. Then, step 1106 activates the additional information display program 1001 to display additional documents to the pertinent user. These additional documents indicated in this step are described later in detail.

Steps 1107 through 1110 are the same as steps 306 through 309 in the first embodiment, respectively. That is, if it is judged that “fit” is entered from a user 107 as the user's evaluation on an document delivered in step 1105 or 1106, step 1108 activates the fitness feedback program 112 to modify the pertinent user's fitness profile 116. Then, if it is judged in step 1109 that “unfit” is entered from a user 107 as the user's evaluation on a delivered document, step 1110 activates the unfitness feedback program 113 to modify the pertinent user's unfitness profile 114.

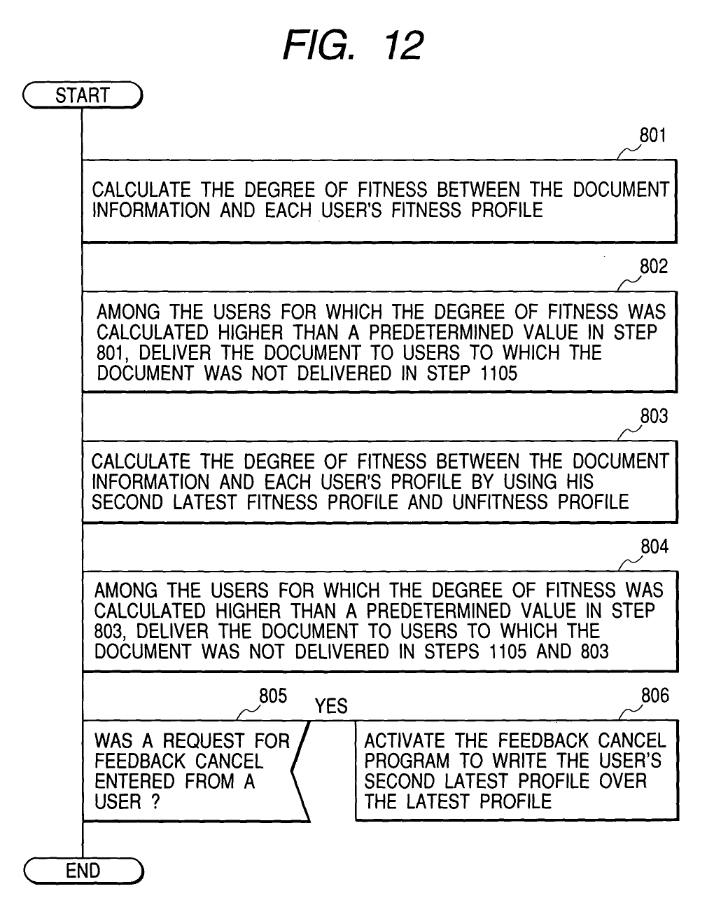

With reference to a PAD of FIG. 12, the following describes the flows of processing by the additional information display program 1001 which is activated by the main program 1010 in step 1106 as shown in FIG. 11. Firstly in step 801, the additional information display program 1001 calculates the degree of fitness between the current fitness profile 116 of each user 107 and the document information received from the document information delivery device 106. Unlike step 1105, only the fitness profile 116 is used in step 801 to calculate the degree of fitness. The unfitness profile 114 is not used in this calculation. Then in step 802, a document where the degree of fitness between the document information and the fitness profile of a user calculated in step 801 is higher than a predetermined value is extracted, and the document is delivered to the users if it has not been delivered to the users in step 1105. Thus, since the user's fitness profile is reflected but his unfitness profile is not reflected, some of the documents that are not delivered to the user in the first embodiment due to “unfitness to his delivery conditions” may be delivered to the user. This allows each user to receive every document containing characteristic character strings representing what the user is interested in. In addition, since such documents are indicated as additional information, each user can reference the document information by taking into consideration the fact that the user's unfitness profile was not reflected. Accordingly, the user may decide not to view these delivered additional documents when the user is busy to check the documents.

Then in step 803, the degree of fitness between the document information and each user's profile is calculated by using his second latest fitness profile and unfitness profile stored in the pre-change profile storing area 1003. This calculation may be done in the same manner as step 1105. Then in step 804, a document where the degree of fitness calculated in step 803 is higher than a predetermined value is extracted, and the document is delivered to the users if it was not delivered to the users in steps 1105 and 803. Thus each user can receive the result of filtering done without the last relevance feedback, allowing the user to compare the delivery result obtained under the latest delivery conditions with that obtained under the second latest delivery conditions and judges whether the last relevance feedback was appropriate or not. In addition, this allows each user to acquire wanted information under his former delivery conditions if the last relevance feedback was not appropriate.

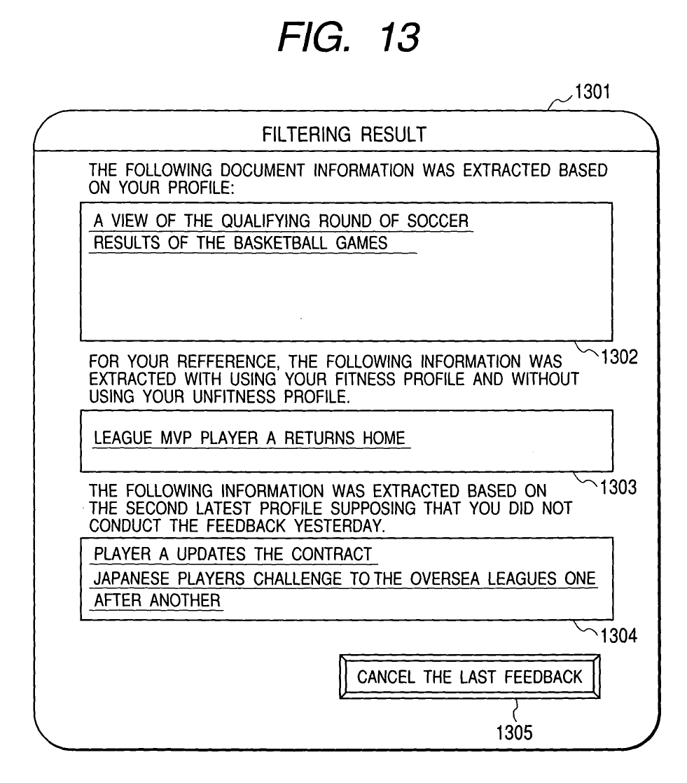

FIG. 13 shows an example of the screen 1301 displayed to a user by the aforementioned steps. Firstly, documents 1302 delivered in step 1105 based on the user's present profile information are displayed. That is, the documents 1302 are delivered by reflecting both current fitness and unfitness profiles of the user. Then a document 1303 is displayed in step 802 in which the present fitness profile was reflected but the unfitness profile was not reflected. Then documents 1304 are displayed in step 804 according to the pre-change profile.

The user checks these documents. If the documents 1302 do not contain desired information but the document 1304 contains desired information, the user judges that the last conducted feedback was not along with his intention. In this case, the user decides to cancel the last feedback and depresses the “Cancel the last feedback” button 1305. If the document 1303 contains desired information, this means that the present unfitness profile 114 may be not appropriate. The user may anticipate that the characteristic character strings contained in the unfitness profile 114 contain an unnecessary characteristic character string with reference to the displayed document 1303. In this case, the user deletes the unnecessary characteristics character string or reduces its weight through input operation. Accordingly, the information filtering system 30 deletes the characteristic character string or reduces its weight.

Then if it is judged in step 805 that a request to cancel the last feedback is entered by the user (the “Cancel the last feedback” button 1305 is depressed in the displayed screen of FIG. 13), step 806 activates the feedback cancel program 1002 to overwrite the user's present fitness profile 116 and unfitness profile 114 respectively by the user's second latest fitness profile and unfitness profile which are stored in the pre-change profile storing area 1003.

This allows the user to restore the delivery conditions (or the user's profile) to its former state changed by the last relevance feedback if the user judges that the last conducted feedback is not appropriate.

Although it is assumed in the description of the third embodiment that only the second latest profile is preserved, it is possible to preserve an older profile or all the past profiles. In the later case, retrieval can be tried according to any past profile that has changed to the present profile through a number of relevance feedbacks.

Note that if the user judges in the displayed screen of FIG. 13 that the documents 1304 are not necessary, the user presses the “Confirm the last feedback” (not shown) in the screen. In this case, the information filtering system 30 proceeds with information delivery processing according to the present profile without canceling the last feedback. In addition, the result display screen 1301 of FIG. 13 may be modified in such a manner that the user enters an evaluation “fit” or “unfit” to each of the documents 1302, 1303 and 1304 so as to conduct further relevance feedback processing.

As described so far, the third embodiment allows the user to acquire desired information even after relevance feedback contrary to his intention is done due to his evaluation on delivered documents. According to the third embodiment, it is also possible for the user to restore his profile to its former state changed by relevance feedback. The description of the third embodiment is complete.

Note that it is assumed in the above description of the embodiments that each delivered document consists only of text information, it may include such other contents as images and sound. In addition, the information filtering system of each embodiment which comprises the display 100, the keyboard 101, the central processing unit 102, the main memory 104 and the bus 103 connecting them may also be located between the document information delivery device 106 and the communication circuit 105 or between the communication circuit 105 and the user 107 in FIG. 1.

As described so far, according to the present invention, if a user makes an operation to change his delivery conditions, the user is notified what documents and characteristic character strings would be no longer delivered due to the change, allowing the user to evaluate the change of his delivery conditions.

1. An information delivery method for delivering document information that fulfill a previously set delivery condition, comprising the steps of:
storing said delivered document information;
if an evaluation that said delivered document information is unfit to said delivery condition is received, extracting characteristic character strings from the evaluated document information;
by using the extracted characteristic character strings, retrieving a document similar to the document evaluated as unfit from the stored documents; and
presenting the retrieved document and the evaluated document.

2. An information delivery method according to claim 1, wherein the retrieval is done for the documents excluding the documents evaluated as unfit by a user to which said documents were delivered among the stored document information.

3. An information delivery method according to claim 1, wherein the retrieval is done for the documents evaluated as fit by a user to which said documents were delivered among the stored document information.

4. An information delivery method according to claim 1, said method further comprising the steps of:
calculating the degree of similarity between the retrieved document information and the evaluated document information; and
if the degree of similarity is higher than a predetermined value, presenting the retrieved document.

5. An information delivery method according to claim 4, said method further comprising the steps of:
extracting characteristic character strings from the retrieved document whose degree of similarity is higher than the predetermined value;
presenting these extracted characteristic character strings and the characteristic character strings extracted from the evaluated documents; and
presenting information based on the presented characteristic character strings to help decide whether or not to accept that the documents whose degree of similarity is higher than the predetermined value will not be delivered.

6. An information delivery method according to claim 4, wherein said delivery condition includes an unfitness profile, which is a condition under which a document unfit for delivery is retrieved, said method further comprising the steps of:
if information indicating that it is accepted that said document whose degree of similarity is higher than the predetermined value will not be delivered is received, adding the characteristic character strings included in said document and the characteristic character strings included in the evaluated document to the unfitness profile; and
if information indicating that it is not accepted that said document whose degree of similarity is higher than the predetermined value will not be delivered is received, adding the characteristic character strings not included in said document but included in the evaluated document to the unfitness profile.

7. An information delivery method for delivering document information to a user which fulfill a delivery condition set previously by the user, comprising the steps of:
storing the delivered documents;
if a request to change the delivery condition is received, changing the delivery condition according to the change request;
searching the stored documents according to the changed delivery condition; and
of the searched documents, presenting a document that does not fulfill the changed delivery condition.

8. An information delivery method according to claim 7, wherein, said method further comprising the steps of:
presenting information to help decide whether or not to accept that the presented document will not be delivered;
if it is accepted that the presented document will not be delivered, storing the new delivery condition set according to said change request; and
if it is not accepted that the presented document will not be delivered, cancelling the change of the delivery condition according to said change request.

9. An information delivery method for delivering documents to a user which fulfill a delivery condition set previously by the user, comprising the steps of:
judging whether a document fulfills the present delivery condition;
if it is judged that the document fulfills the present delivery condition, transmitting the document to the user who has set said present delivery condition; and
if said present delivery condition is set by changing said previously set delivery condition, retrieving documents which fulfill the previously set delivery condition; and
of the retrieved documents which fulfill said previously set delivery condition, transmitting to the user a document that has not been delivered to the user.

10. An information delivery method according to claim 9, said method further comprising the step of transmitting to the user who has set said present delivery condition the documents that are not delivered to the user among the documents which fulfill said present delivery condition.

11. An information delivery method according to claim 9, said method further comprising the step of presenting the documents that fulfill said present delivery condition and the documents that fulfill said previously set delivery condition to the user who has set said delivery condition.

12. An information delivery method according to claim 9, wherein:
said delivery condition includes a fitness profile, which is a condition under which a document fit for delivery is retrieved, and an unfitness profile, which is a condition under which a document unfit for delivery is retrieved; and
to retrieve a document which fulfills said present delivery condition, the fitness profile included in said present delivery condition is used.

13. An information delivery method according to claim 12, wherein to retrieve a document that fulfills said previously set delivery condition, the fitness profile and unfitness profile included in said previously set delivery condition are used.

14. An information delivery method according to claim 11, said method further comprising the steps of:
based on said presented documents, presenting information to help decide whether or not to cancel the change of said previously set delivery condition to said present delivery condition; and
if information indicating that it is decided to cancel said change is received, setting said previously set delivery condition as the latest delivery condition.

15. An information delivery apparatus delivering document information which fulfill a previously set delivery condition, said apparatus comprising:
storage means for storing said delivered document information;
extracting means for extracting characteristic character strings from the evaluated document information if an evaluation that said delivered document information is unfit to said delivery condition is received;
retrieval means for retrieving a document similar to the document evaluated as unfit from the documents stored in said storage means by using the characteristic character strings extracted by said extracting means; and
presentation means for presenting the document extracted by said retrieval means and the evaluated document.

16. An information delivery apparatus according to claim 15, further comprising:
calculation means for calculating the degree of similarity between the retrieved document information and the evaluated document information, wherein said presentation means presents the retrieved document if the degree of similarity is higher than a predetermined value.

17. An information delivery apparatus according to claim 16, wherein:
said extracting means extracts characteristic character strings from the retrieved document whose degree of similarity is higher than the predetermined value; and
said presentation means presents not only the characteristic character strings extracted by said extracting means and the characteristic character strings included in the evaluated document but also information based on the presented characteristic character stings to help decide whether or not to accept that the document whose degree of similarity is higher than the predetermined value will not be delivered.

18. An information delivery apparatus according to claim 17, wherein said delivery condition includes an unfitness profile, which is a condition under which a document unfit for delivery is retrieved, said apparatus further comprising:
adding means for adding, if information indicating that it is accepted that said document whose degree of similarity is higher than the predetermined value will not be delivered is received, the characteristic character strings included in said document and the characteristic character strings included in said evaluated document to said unfitness profile and; for adding, if information indicating that it is not accepted that said document whose degree of similarity is higher than the predetermined value will not be delivered is received, the characteristic character strings not included in said document but included in the evaluated document to said unfitness profile.

19. A computer program executed in an information delivery system for delivering document information which fulfill a previously set delivery condition, said computer program comprising the steps of:
storing the delivered documents;
if a request to change the delivery condition is received, changing the delivery condition according to the change request;
searching the stored documents according to the changed delivery condition; and
of the searched documents, presenting a document that does not fulfill the changed delivery condition.

20. A computer program according to claim 19, further comprising the step of:
presenting information to help decide whether or not to accept that the presented documents will not be delivered;
if it is accepted that the presented documents will not be delivered, storing a new delivery condition set according to said change request; and
if it is not accepted that the presented documents will not be delivered, canceling the change of the delivery condition according to said change request.
